(19) United States
(12) Patent Application Publication
(10) Pub. No.: US 2009/0059563 A1
(43) Pub. Date: Mar. 5, 2009

(54) ILLUMINATION DEVICE FOR DISPLAY DEVICE, DISPLAY DEVICE, AND TELEVISION RECEIVER

(75) Inventors: Yoshiki Takata, Mie (JP); Masashi Yokota, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 11/909,412

(22) PCT Filed: Apr. 24, 2006
(86) PCT No.: PCT/JP2006/308568

§ 371 Date: Sep. 21, 2007

(30) Foreign Application Priority Data
Jun. 28, 2005 (JP) 2005-188890

(51) Int. Cl. G09F 13/08

(52) U.S. Cl. 362/97.1

(57) ABSTRACT

In a display device having a liquid crystal panel and a backlight unit, an optical sheet group provided on a surface of the backlight unit facing the liquid crystal panel is curved so as to form a convex shape in a direction opposite to the liquid crystal panel. In this way, a wrinkle on the optical sheet provided in the display device is prevented while avoiding deterioration in the displaying quality.

### BACKGROUND OF THE INVENTION

1. Field of the Invention

The present invention relates to a backlight unit (illumination device) for use in a transmissive display device, a display device, and a television receiver. More specifically, the present invention relates to a technology for preventing a wrinkle which cyclically occurs on an optical sheet (sheet member) provided to the transmissive display device, while avoiding deterioration in the displaying quality.

2. Description of the Related Art

In recent years, flat panel displays such as liquid crystal display devices have been widely spreading as monitors for television receivers and PCs (personal computers). Particularly, in the field of television receivers, there has been a demand for larger display screens.

A liquid crystal display device is a representative example of non-light emitting display devices. A liquid crystal display device can be, for example: a transmissive liquid crystal display device which displays an image by using light emitted from its backlight unit (illumination device); a reflective liquid crystal display device which displays an image by reflecting light incident on its display surface; or a transmissive/reflective liquid crystal display device having both of the above functions. Note that, for a large display screen, a transmissive liquid crystal display device is adopted in general. Further, the backlight unit to be provided in the transmissive liquid crystal display device can be: a direct-type backlight unit having a light source (plural fluorescent lamps or the like) which is placed directly on the backside of a display region of a display panel; or an edge-type (edge-light type) backlight unit in which a light source is arranged in an outer edge portion of a display region, and light from the light source is reflected and dispersed so as to realize a surface light source.

In general, each of these backlight units includes: a reflection plate or an optical waveguide for reflecting and dispersing light from the light source, thus serving as a surface light source; and optical sheets (sheet members). Examples of the optical sheets are: a dispersion plate and a dispersion sheet each for equalizing the brightness of plane emission; a lens sheet (lens film) for improving the luminance at the front surface of the display; a polarization reflecting sheet for converting non-polarized light into linearly polarized light, or the like. That is, the backlight unit includes: a lamp house having the light source; and the optical sheet such as a dispersion plate (or optical waveguide), a dispersion sheet, a lens sheet, or a polarization reflecting sheet, which is placed on a surface of the lamp house facing the display panel.

Incidentally, when a liquid crystal display device is upsized, the size of the optical sheet is also increased. Therefore, the optical sheet is easily bent or wrinkled. In other words, an optical sheet which is a two dimensional member having a thin thickness, is easily deformed in the thickness direction (the third direction). Accordingly, the optical sheet expands or contracts due to heat generated by light from light source; a change in the surrounding temperature; or absorption of moisture. As a result, cyclical deformation (wavelike wrinkle) occurs on the optical sheet. FIG. 10 is a perspective diagram showing an optical sheet having creases.

When the optical sheet is wrinkled, a viewer recognizes a wrinkle on the optical sheet as an unevenness of displaying.

In view of that, for example, Patent Citation 1 (Japanese Unexamined Patent Publication No. 233828/2004, Tokukai 2004-233828; Published on Aug. 19, 2004) discloses a technology for preventing a surface sheet such as lens sheet and/or dispersion sheet, which is placed on a lamp house, from deforming into an undesirable shape due to heat generated by a fluorescent lamp. In the technology, the surface sheet is supported so that the surface sheet is curved and forms a convex shape in a direction towards a liquid crystal panel, and so that the surface sheet and the liquid crystal panel contact each other at the center portion of the display panel.

However, in the technology of the Patent Citation 1, the surface sheet and the liquid crystal panel contact each other at the center portion of the display panel. Accordingly, an excessive brightness or the like which deteriorates the displaying quality occurs at the portion where the surface sheet and the display panel contact. Here, the excessive brightness is a phenomenon in which high luminance display (e.g., white display) is performed in a region where low luminance display (e.g., black display) should be performed. Further, when the surface sheet deforms by a large amount, the area of the portion where the surface sheet and the liquid crystal panel contact each other increases. This causes expansion of a region where the displaying quality is deteriorated.

### SUMMARY OF THE INVENTION

In order to overcome the problems described above, preferred embodiments of the present invention prevent wrinkles from being formed on an optical sheet (sheet member) that is to be provided in a display device, while avoiding deterioration of a displaying quality.

An illumination device according to a preferred embodiment of the present invention is an illumination device, for use in a transmissive display device which performs displaying by using light from the illumination device having passed through a display panel, including: a light source; and a sheet member for passing light from the light source to outside the illumination device, wherein the sheet member is curved so as to form a convex shape in a direction towards inside the illumination device.

In the configuration, the direction in which the sheet member is displaced due to bending of the optical sheet is limited to the direction towards the inside, even if the sheet member expands or contracts. Thus, cyclic deformation (wavelike wrinkle) on the sheet member is prevented.

Further, in the configuration, the displacement direction of the sheet member is limited to the direction towards the inside the illumination device. Therefore, the sheet member does not contact the display panel. Thus, it is possible to prevent deterioration of the displaying quality which is attributed to the sheet member contacting the display panel. As a result, with the configuration, it possible to prevent the sheet member from being wrinkled while avoiding deterioration of the displaying quality.

According to a preferred embodiment of the present invention, a display device is an illumination device, for use in a transmissive display device which performs displaying by using light from the illumination device having passed through a display panel, including: a sheet member for passing light from the light source, wherein the sheet member is curved so as to form a convex shape in a direction opposite to the display panel.

With the configuration, the direction in which the sheet member is displaced due to bending of the optical sheet is limited to the direction towards the inside, even if the sheet member expands or contracts. Thus, cyclic deformation (wavelike wrinkle) on the sheet member is prevented.

Further, in the configuration, the displacement direction of the sheet member is limited to the direction towards the inside the illumination device. Therefore, the sheet member does not contact the display panel. Thus, it is possible to prevent deterioration of the displaying quality which is attributed to the sheet member contacting the display panel. In short, with the configuration, it is possible to prevent the sheet member from being wrinkled while avoiding deterioration of the displaying quality.

A television receiver according to another preferred embodiment of the present invention includes any of the above-described display devices. Thus, it is possible to prevent the sheet member from being wrinkled while avoiding deterioration of the displaying quality.

These and additional elements, features, characteristics, advantages and strengths of the present invention will be made clear by the description of preferred embodiments thereof below. Further, the advantages of preferred embodiments of the present invention will be evident from the following explanation in reference to the drawings.

### BRIEF DESCRIPTION OF THE DRAWINGS

FIG. 1 is a cross sectional view showing a schematic configuration of a display device (television receiver) according to a preferred embodiment of the present invention.

FIG. 2 is a block diagram showing a circuit configuration of the display device according to a preferred embodiment of the present invention.

FIG. 3 is a perspective diagram showing an exemplary optical sheet provided in the display device according to a preferred embodiment of the present invention.

FIG. 4 is a perspective diagram of another optical sheet provided in the display device according to a preferred embodiment of the present invention.

FIG. 5 is a cross sectional view showing an alternative form of the sheet supporting section provided in the display device according to a preferred embodiment of the present invention.

FIG. 6 is a cross sectional view showing an alternative form of the sheet supporting section provided in the display section according to a preferred embodiment of the present invention.

FIG. 7 is a cross sectional view showing an exemplary configuration of another display device according to a preferred embodiment of the present invention.

FIG. 8 is a perspective diagram showing a warpage of the optical sheet provided in the display device according to a preferred embodiment of the present invention.

FIG. 9 is a cross sectional view showing an alternative form of method of supporting the optical sheet provided in the display device according to a preferred embodiment of the present invention.

FIG. 10 is a perspective diagram showing wavelike wrinkles on an optical sheet provided in a conventional display device.

### DETAILED DESCRIPTION OF THE PREFERRED EMBODIMENTS

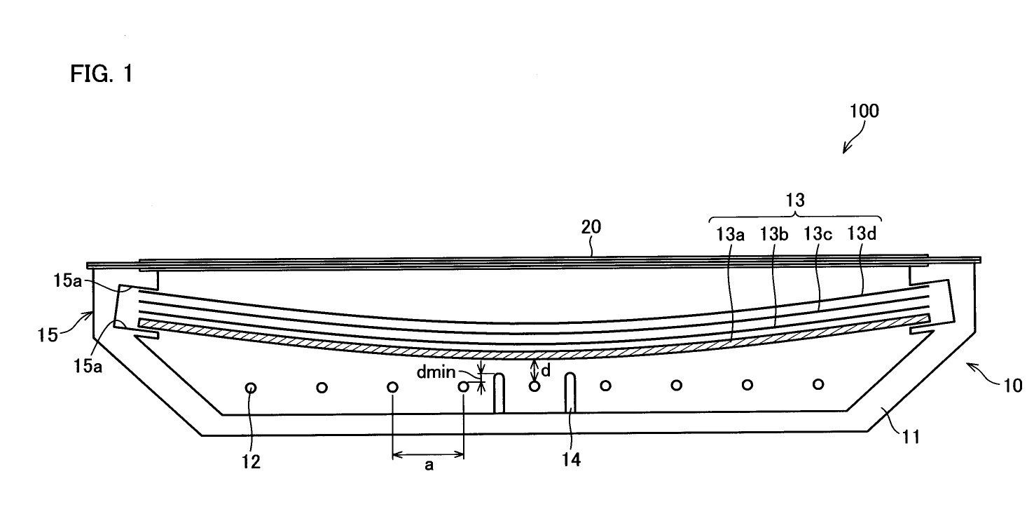

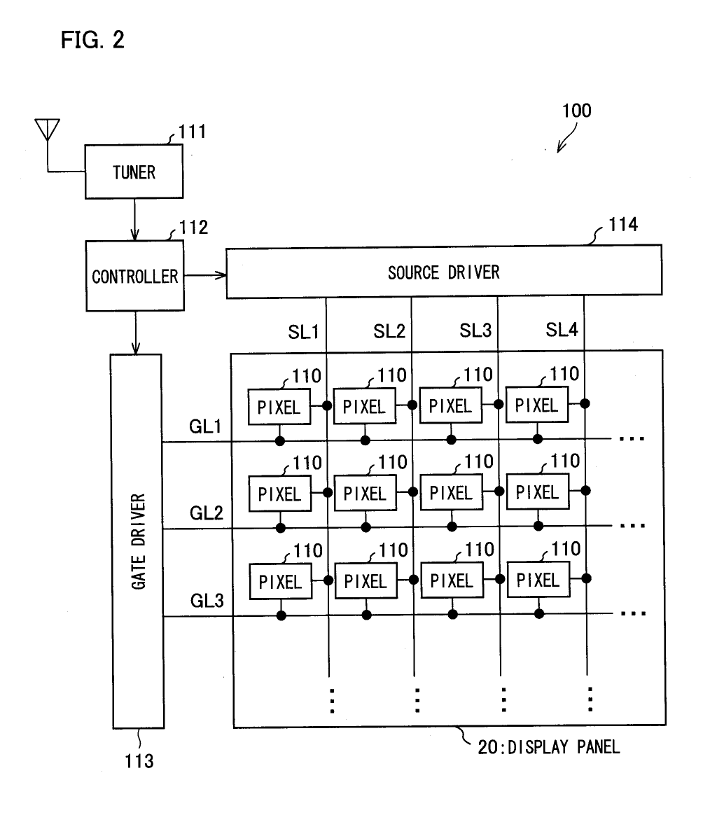

The following describes preferred embodiments of the present invention. FIG. 1 is a cross sectional view showing a schematic configuration of a display device (television receiver) 100 of the present preferred embodiment. Further, FIG. 2 is a block diagram showing a circuit configuration of the display device 100.

As shown in FIG. 1, the display device 100 preferably includes: a liquid crystal panel (display panel) 20; and a backlight unit 10.

First described below are the configuration of the liquid crystal panel 20 and how the display device 100 performs displaying. As shown in FIG. 2, the display device 100 preferably includes: the liquid crystal panel 20 in which pixels 110 are arranged in a matrix manner; a tuner 111; a controller 112; a gate driver 113; a source driver 114; or the like.

The tuner (image receiving means) 111 receives television broadcasting, generates an image signal according to an image transmitted by the television broadcasting, and transmits the image signal to the controller 112. Examples of the television broadcasting received by the tuner 111 are: terrestrial television broadcasting; broadcasting using an artificial satellite such as BS (Broadcasting Satellite) digital broadcasting or CS (Communication Satellite) digital broadcasting; or cable television broadcasting.

The controller 112 generates various control signals for driving a gate driver 113 and a source driver 114, according to the image signal having received from the tuner 111. The controller 112 then transmits the control signals to the gate driver 113 and source driver 114.

The liquid crystal panel 20 has two transparent substrates which face each other. Between the transparent substrates, a medium containing liquid crystal molecules is enclosed. Further, the liquid crystal panel 20 further includes: a plurality of data signal lines SL1 to SLn (where n is an integer of not less than 2); and a plurality of scan signal lines GL1 to GLm (where m is an integer of not less than 2) which respectively intersect the data signal line SL1 to SLn. With the data signal lines SL1 to SLn and the scan signal lines GL1 to GLm, the pixels 110 are arranged in a matrix manner.

Each of the pixels 110 is provided with a switching element (not shown) made of, for example, an FET (Field Effect Transistor) or a TFT (thin film transistor). The gate electrode of each switching element is connected to a scan signal line GLi. The drain electrode is connected to a data signal line Sli. The source electrode is connected to one of a pair of electrodes of a pixel capacitor of the pixels. The pixel capacitor includes: a medium containing liquid crystal molecules, and the pair of electrodes for applying electric field to the medium. Further, another one of the electrodes of the pixel capacitor is connected to an electrode line (not shown) which is shared amongst all the pixels 110.

Thus, when the gate driver 113 selects the scan signal line GLi (where i is an integer of not less than 1), at a timing according to a control signal from the controller 112, the switching element connected to the scan signal line GLi becomes conductive, and a signal voltage determined based on a display data signal input from the controller 112 is supplied from the source driver 114 to the pixel 110 via the data signal line SLi (where i is an integer of not less than 1). Ideally, when a selected period of the scan signal line GLi ends and the switching element is shutoff, each of the pixels 110 retains the voltage at the time of shutting off the switching element, while the switching element is being shutoff.

In this way, voltage to be applied to each pixel is controlled according to an image of television broadcasting having been received by the tuner 111. Thus, the orientation of the liquid crystal molecules in each pixel is controlled according to the image to be displayed. This controls the transmissivity (in relation to light from the backlight unit 10) of each pixel, thereby displaying the image. Here, it is possible to make the liquid crystal panel 20 capable of performing color displaying by providing the liquid crystal panel 20 with a color filter.

Next, the backlight unit 10 is described in detail. The backlight unit 10 includes: a lamp house 11; a lamp 12; an optical sheet group 13; a sheet deformation restricting section 14; and a sheet supporting section 15.

Inside the lamp house 11, a plurality of linear lamps 12 are provided. The linear lamps 12 are arranged substantially in parallel to each other. Further, the lamp house 11 includes therein a reflection film (not shown) for reflecting light emitted from each of the lamps 12.

On one surface of the lamp house 11 facing the liquid crystal panel 20, the optical sheet group 13 is arranged. The optical sheet group 13 includes optical sheets (sheet members) which are, for example: a dispersion plate 13a; a lens sheet 13b; a dispersion sheet 13c; or a polarization reflecting sheet 13d.

Note that the configuration of the optical sheet group 13 is not limited to the above. For example, the optical sheet group 13 may exclude some of the above-described optical sheets. Further, the optical sheet group 13 may include a plurality of some of the above-described optical sheets. Further, the optical sheet group 13 may include an optical sheet having a different function from those of the above-described optical sheets.

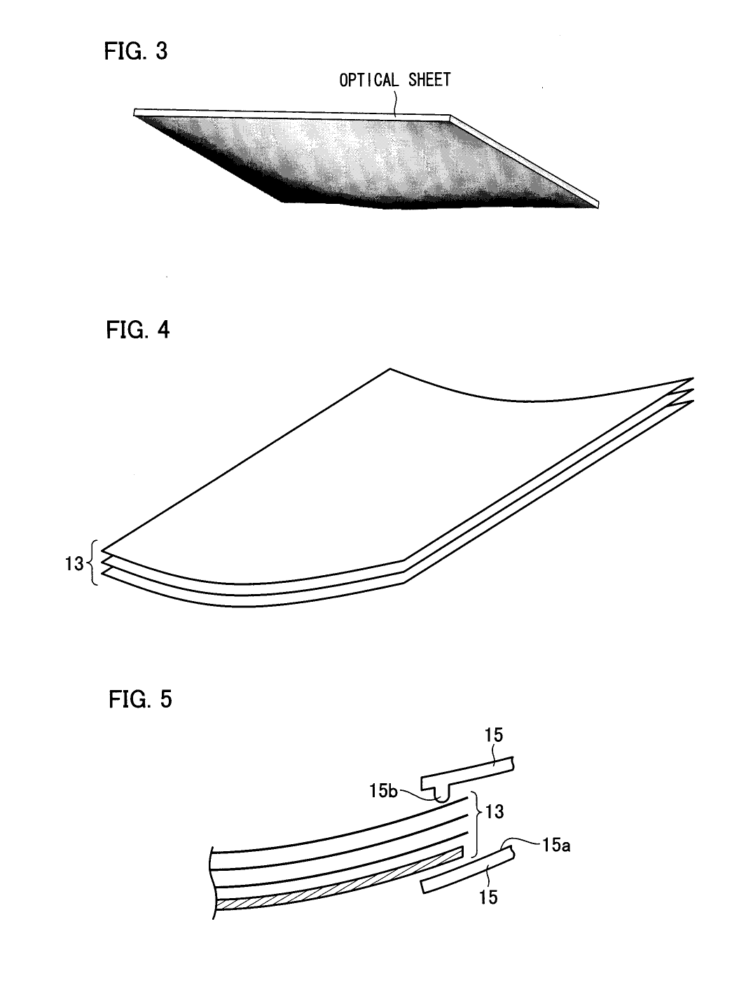

FIG. 3 is a perspective diagram illustrating an exemplary optical sheet included in the optical sheet group 13. As shown in the figure, each optical sheet in the optical sheet group 13 forms a convex shape which is gently curved in a spherical manner to one direction. For example, such a convex shape can be formed by performing a pressing process using a spherical die with respect to a plane optical sheet, or by subjecting the optical sheet to heat after the pressing process using the die.

Further, the optical sheet group 13 is supported by the sheet supporting section 15 in such a manner that the optical sheet group 13 forms a convex shape in a direction opposite to the liquid crystal panel 20. The sheet supporting section 15 is provided in the lamp house 11. Here, the sheet supporting section 15 supports the optical sheet group 13 so that the optical sheet group 13 does not contact the liquid crystal panel 20, even if the optical sheet group expands or contracts due to absorption of heat or moisture. This sheet supporting section 15 is provided so as to allow expansion and contraction of the optical sheet group 13. In other words, as shown in FIG. 1, a movement of the optical sheet group 13 in a substantially perpendicular direction relative to the liquid crystal panel 20 (a direction towards the liquid crystal panel 20) or in the opposite direction (a direction towards the backlight unit 10) is restricted by a contact portion where the sheet supporting section and the optical sheet group 13 contact each other. Meanwhile, the contact portion allows displacement of the optical sheet group along a sheet supporting surface 15a of the sheet supporting section 15 (i.e., in a direction the optical sheet group 13 is curved).

Further, the lamp house 11 includes a sheet deformation restricting section 14 which restricts the deformation of the optical sheet group 13 in the direction towards the lamp 12 so that the distance between the lamp 12 and the optical sheet group 13 is kept more than a predetermined value dmin, even if the optical sheet group 13 deforms due to absorption of heat or moisture. The sheet deformation restricting section 14 projects from the bottom surface of the lamp house 11 (from the surface of the lamp house 14 facing the liquid crystal panel 20). Here, the shape of the sheet deformation restricting section 14, the number of sheet deformation restricting sections 14, and the position of the sheet deformation restricting section 14 are not particularly limited, provided that the deformation (amount of bending) of the optical sheet group 13 in the direction opposite to the liquid crystal panel 20 (in a direction towards inside the backlight unit 10) is restricted. Note however that it is preferable that the sheet deformation restricting section 14 be capable of restricting deformation of the optical sheet group 13 in the direction towards the lamp 12 so that the distance between the optical sheet group 13 and the lamp 12 is kept more than a predetermined value dmin. Further, the color of the sheet deformation restricting section 14 is not particularly limited. However, in consideration of preventing deterioration in light using efficiency, the sheet deformation restricting section 14 is preferably transparent or white.

The above mentioned predetermined value (minimum distance between the lamp 12 and the optical sheet group 13) dmin is set at a value within such a range that a viewer is not able to see the figure of the lamp 12 at the time of displaying an image. Here, the larger the value derived from d×h/a (where: a is an interval of the lamp 12 to another lamp 12; d is the distance between the lamp 12 and the optical sheet group 13; and h is the haze of the dispersion plate 13a), the harder the viewer is able to see the figure of the lamp 12. That is, the above predetermined value dmin is set according to the interval a of the lamp 12 to another lamp 12, and the haze h of the dispersion plate 13a so that the figure of the lamp 12 is not seen by the viewer.

As mentioned above, in the backlight unit 10 of the present preferred embodiment, the optical sheet group 13 is arranged on the surface on the side of the liquid crystal panel 20. This optical sheet group 13 has a convex shape which is gently curved in a direction opposite to the liquid crystal panel 20.

Accordingly, even when the optical sheet group 13 expands or contracts due to absorption of heat or moisture, the optical sheet group 13 is only displaced in the direction towards the lamp 12 (uniformly bent in a half cycle manner). Thus, it is possible to prevent a wavelike wrinkle (cyclic deformation) on the optical sheet group 13.

Further, the optical sheet group 13 is supported so that the optical sheet group 13 forms a convex shape in a direction opposite to the liquid crystal panel 20. Therefore, the optical sheet group does not contact the liquid crystal panel 20, even if the optical sheet group 13 expands or contracts. Thus, deterioration in the displaying quality due to an excessive brightness or the like caused by the optical sheet group 13 contacting the liquid crystal panel 20 is prevented, and therefore a high-quality displaying of an image is possible.

Further, the sheet supporting section 15 supporting the optical sheet group 13 restricts the movement of the optical sheet group 13 in a substantially perpendicular direction relative to the substrate surface of the liquid crystal panel 20, while it supports the optical sheet group 13 so as to allow displacement of the optical sheet group 13 along the sheet supporting surface 15a.

With this, it is possible to reduce displacement of the optical sheet group 13 in the normal direction of the substrate surface of the liquid crystal panel 20, even if the optical sheet group 13 expands or contracts.

Further, the backlight unit 10 of the present preferred embodiment includes the sheet deformation restricting section 14 which restricts deformation of the optical sheet group 13 towards the lamp 12 so as to keep the distance between the lamp 12 and the optical sheet group 13 more than a predetermined value dmin, even if the optical sheet group 13 expands or contracts. Further, the above mentioned predetermined value dmin is set at a value within such a range that a viewer is not able to see the figure of the lamp 12 at the time of displaying an image.

Therefore, the figure of the lamp 12 is not seen by the viewer even if the optical sheet group 13 expands or contracts. Thus, deterioration in the displaying quality is prevented.

The present preferred embodiment deals with a case where each optical sheet in the optical sheet group 13 has a convex shape which is curved in one direction. However, the present invention is not limited to this. For example, the optical sheet itself may be formed in a plane shape. In this case, the optical sheet may be supported and curved by the sheet supporting section 15 so as to form a convex shape in a direction towards the lamp 12, when the optical sheet is set in the backlight unit 10. Further, the following is also possible. Namely, of the optical sheets in the optical sheet group 13, one or more optical sheets may be formed in a spherical shape beforehand, and the rest of the optical sheet(s) may be in a plane shape unless an external force is applied. The optical sheet(s) in the plane shape may be curved by the sheet supporting section 15 at a time of setting the optical sheet(s) in the backlight unit 10.

Further, in the present preferred embodiment, all the optical sheets in the optical sheet group 13 are preferably set so as to be curved. However, the optical sheet group 13 is not limited to this. For example, the optical sheet group 13 may include at least one optical sheet that is curved in a direction opposite to the liquid crystal panel 20. For example, the curved optical sheet may be only an optical sheet closest to the liquid crystal panel 20, or an optical sheet which can be most easily bent. Further, the curved optical sheet may be only a dispersion plate.

Further, the optical sheets of the optical sheet group 13 do not necessarily have to have an identical curvature or an identical shape, and may respectively have different shapes.

Further, by suitably determining how the optical sheets are curved, it is possible to converge light from the lamp 12 in a desirable direction. That is, it is possible to arrange the optical sheets so that a quantity of light from the lamp 12 is evenly distributed in displaying directions. Alternatively, the optical sheet may be arranged so that a quantity of light directed to a specific displaying direction is larger than quantities of light directed to other displaying directions.

Further, in the present preferred embodiment, the optical sheet group 13 is set so as to form a spherical convex shape. However, the optical sheet group 13 is not limited to this, provided that the optical sheet group 13 is curved in a direction opposite to the liquid crystal panel 20. For example, as shown in FIG. 4, amongst the edges of the rectangular optical sheet, each of two sides opposite to each other may be in a linear shape, and the rest of the two sides may be curved to form an arch. Here, if the display device 100 is to be set upright (i.e., the display device 100 is set so that the substrate surface of the liquid crystal panel 20 is substantially parallel to the vertical direction), it is preferable that two sides substantially perpendicular to the vertical direction (two sides arranged at the top and bottom in relation to the vertical direction) be curved. In this way, it is possible to prevent the optical sheet group 13 from being curved by its weight, and the configuration for supporting the optical sheet group 13 is simplified.

Further, the sheet supporting section 15 is not limited to that shown in FIG. 1, provided that the sheet supporting section 15 is able to support the optical sheet group 13 so that the optical sheet group 13 forms a convex shape in a direction opposite to the liquid crystal panel 20. For example, as shown in FIG. 5, it is possible to support the optical sheet group 13 by a punctiform sheet supporting surface (contacting point) 15b. In FIG. 5, only one side of the optical sheet group 13 is supported by the punctiform sheet supporting surface 15b. However, it is possible to support the both sides of the optical sheet group 13 by the punctiform contact surfaces 15b. As described, it is preferable that the sheet supporting section 15 restricts a movement of the optical sheet group 13 in a direction substantially perpendicular to the substrate surface of the liquid crystal panel 20, while supporting the optical sheet group 13 in such a manner as to be displaceable in a direction the optical sheet group 13 is curved.

Further, the material of the sheet supporting section 15 (i.e., contact surface 15a or the material of the contact surface 15b) is not particularly limited. For example, the sheet supporting section 15 can be made of a metal material or a resin.

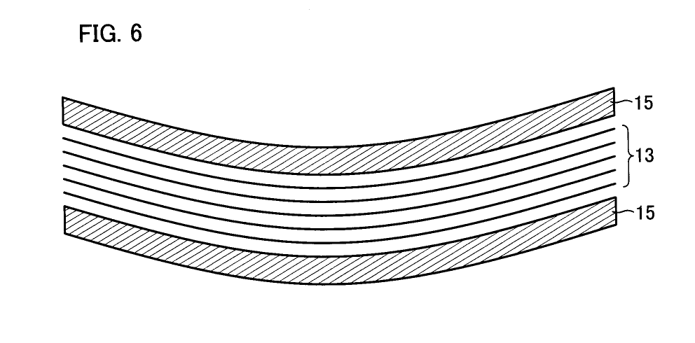

Further, when the optical sheet group 13 shown in FIG. 4 is used, the sheet supporting section 15 may be provided as shown in FIG. 6 so as to support the optical sheet group 13 by the two curved edges of the optical sheet group 13, along their curvatures. Here, in this case, in regard to two edges of the optical sheet group 13 that are in a linear shape, for example, it is preferable that the optical sheet group 13 be supported by using the sheet supporting section 15 of FIG. 1, or that of FIG. 5, in such a manner that the movement of the optical sheet group 13 in substantially perpendicular direction to the substrate surface of the liquid crystal panel 20 is restricted, while the displacement of the optical sheet group 13 along the curvature of the optical sheet group 13 is enabled. With this configuration, the sheet supporting section 15 also serves as a sheet deformation restricting section 14 which restricts the movement of the optical sheet group 13 in the normal direction in relation to the substrate surface of the liquid crystal panel 20.

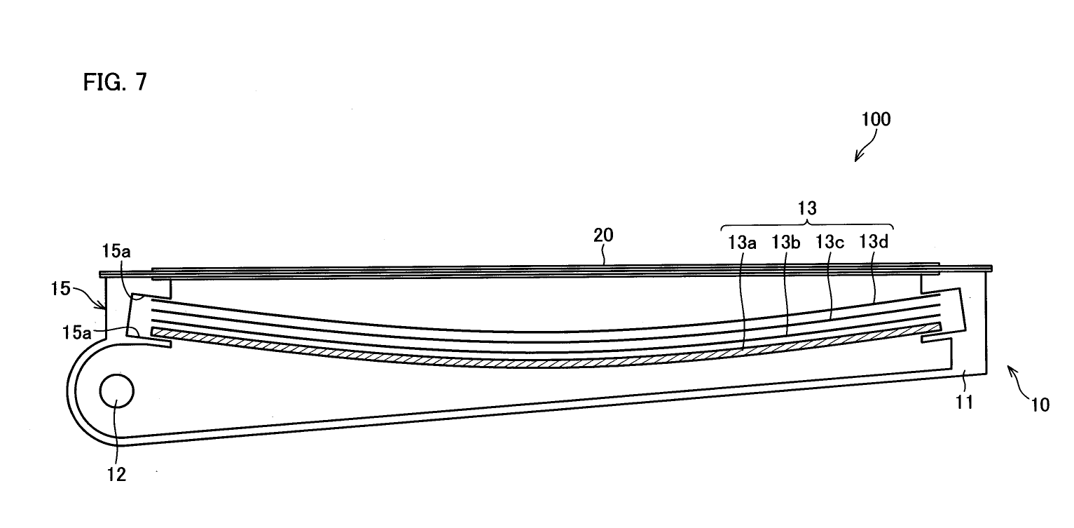

Further, the present preferred embodiment deals with a case of a direct backlight unit 10 such that the lamp 12 preferably is arranged right below the display region of the liquid crystal panel 20. However, the backlight unit of the present preferred embodiment is not limited to this. For example, as shown in FIG. 7, it is possible to adopt an edge-type backlight unit 10 in which case a lamp 12 serving as a light source is arranged in an outer edge portion of a display region (i.e., a region which does not overlap the display region when viewed from the normal direction of the substrate surface of the liquid crystal panel 20), and light from this lamp 12 is reflected and dispersed with a use of an optical waveguide or a reflection plate or the like (not shown) provided in a lamp house 11, thereby realizing a surface light source for emitting light towards the liquid crystal panel 20.

Further, the lamp (light source) 12 of the backlight unit 10 is not limited as long as necessary light for displaying an image is emitted. For example, the lamp 12 may be a fluorescent lamp such as a cold-cathode tube, or an LED. Further, the lamp 12 is not limited to a linear light source, and it is possible to adopt a punctiform light source.

As described above, the type and the number of optical sheets (sheet members) included in the optical sheet group 13 can be suitably determined, and are not particularly limited. Here, a direct backlight unit typically includes: 0 to 2 lens sheet(s); 1 to 3 dispersion sheet(s); 0 to 1 polarization reflecting sheet; and a dispersion plate. Further, an edge-type backlight unit typically includes: 0 to two lens sheet(s); 1 to 3 dispersion sheet(s); 0 to 1 polarization reflecting sheet; and an optical waveguide.

Further, in the present preferred embodiment, the optical sheet group 13 is preferably provided in the backlight unit 10. However, the optical sheet group 13 does not necessarily have to be provided in the backlight unit 10. That is, for example, the sheet supporting section 15 may be provided in a member other than the backlight unit 10, provided that the optical sheet group 13 (or at least one optical sheet in the optical sheet group 13) is arranged between the backlight unit 10 and the liquid crystal panel 20.

Further, the present preferred embodiment deals with a case of display device having the liquid crystal panel 20. However, the present invention is not limited to this. The present invention is applicable to any transmissive display device which displays an image by transmitting light from a backlight.

Further, the present preferred embodiment deals with a case where the present invention is applied to a television receiver. However, the present invention is not limited to this. For example, the present invention is also applicable to a monitor of a personal computer. In this case, the tuner 111 is omitted, and the image signal of an image to be displayed may be input from the personal computer to a controller 112. Further, the display device of the present preferred embodiment may be, for example, any display device which is mounted or connected on/to various devices. Example of such a display device are: an in-vehicle monitor to be mounted in an automobile (e.g. for navigation device, for displaying various meters, for displaying an image around the automobile which is taken by a camera or the like); a display device to be mounted on various electronic devices such as a mobile phone, a digital camera, a digital video camera, or the like; or various monitors each for displaying an image taken stored in a storage medium such as a DVD, a video tape, or a hard disk, or for displaying an image taken by a camera or the like.

Further, the liquid crystal panel 20 shown in FIG. 1 preferably has a flat display surface. However, the liquid crystal panel 20 is not limited to this and may have a curved display surface. For example, the liquid crystal panel 20 may have a curved surface corresponding to the shape of the optical sheet group 13.

An examination was conducted to confirm and assess the effects of various preferred embodiments of the present invention. The result is as detailed below. In the examination, an LCD module or a television set including an optical sheet group was left for 24 hours under conditions of 40° C. and 95% Rh. Then, the LCD module was left another hour under conditions of 25° C. and 50% Rh (for preventing condensation). After that, the backlight is turned on to confirm the respective displaying quality of white displaying and black displaying on the panel. Specifically, the following items were confirmed every hour within 24 hours after the backlight is turned on: (i) an excessive brightness during black displaying; and (ii) unevenness in the brightness, attributed to a wrinkle on the sheet. Further, when the wrinkle or the excessive brightness occurred, the time taken for the wrinkle or the excessive brightness to disappear was measured (approximately 48 hours at the most).

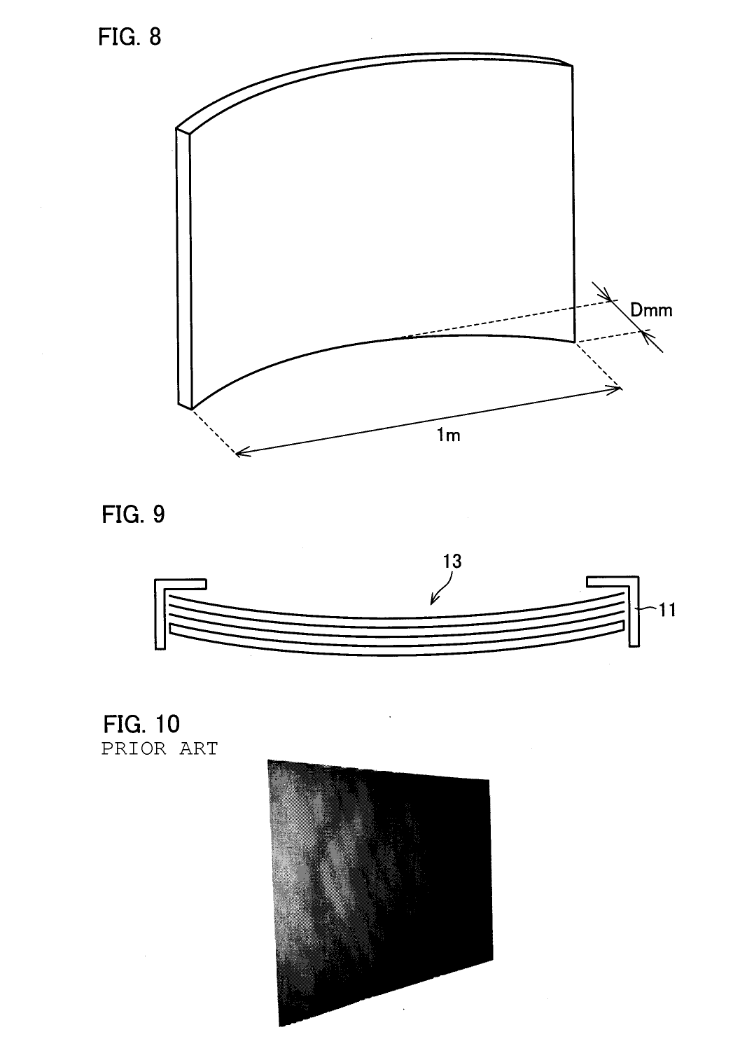

Here, in the present invention, when considering a warpage amount D (see FIG. 8) occurring at an edge of 1 m in width of a sheet member closest to the lamp house 11 amongst those in the optical sheets 13, the following tendency was confirmed. The warpage amount D was usually about 4 to 5 mm, and varied within a range from the minimum of 2 mm to the maximum of 8 mm.

In preferred embodiments of the present invention, suitable curvature was obtained when the thickness of the sheet was 2 mm and the warpage amount was within the above-mentioned range (i.e., 2 mm to 8 mm). However, the sheet contained a curvature that caused slightly excessive brightness during the black displaying. A sheet of 3 mm in thickness was more effective and, no excessive brightness occurred during black displaying. These results were confirmed in a 65′ and 57′ liquid crystal displays.

Further, in the above-described configuration, the optical sheet group 13 is kept from moving in a substantially perpendicular direction to the substrate surface of the liquid crystal panel 20. In order to absorb thermal deformation (expansion/contraction) of the optical sheet group 13, the optical sheet group 13 is made displaceable in the direction of its curvature.

However, a display device of the present invention is not limited to such a configuration. For example, a configuration as shown in FIG. 9 is also possible. Specifically, in a display device shown in FIG. 9, the optical sheet group 13 is fixed by its ends with a use of a lamp house 11 so that a movement of the optical sheet group 13 in the direction of its curvature is restricted. In this configuration, the optical sheet group 13 moves, due to thermal deformation, in a substantially perpendicular direction relative to the substrate surface of the liquid crystal panel 20. This necessitates an extra redundancy for the range from d to dmin in which the optical sheet group 13 can move.

As described above, an illumination device according to various preferred embodiments of the present invention is an illumination device for use in a transmissive display device which displays an image by using light from the illumination device having been transmitted through a display panel, including: a light source; and a sheet member for passing light from the light source to the outside of the illumination device, wherein the sheet member is curved so as to form a convex shape in a direction towards inside the illumination device. Here, examples of the sheet member are a lens sheet, a dispersion sheet, a polarization reflecting sheet, a dispersion plate, an optical waveguide, or the like. A sheet member having other optical functions can be also used. Further, the sheet member may be a combination of the above listed sheet members.

In the configuration, the direction in which the sheet member is displaced due to bending of the optical sheet is limited to the direction towards the inside, even if the sheet member expands or contracts. Thus, cyclic deformation (wavelike wrinkle) on the sheet member is prevented.

Further, in the configuration, the displacement direction of the sheet member is limited to the direction towards the inside the illumination device. Therefore, the sheet member does not contact the display panel. Thus, it is possible to prevent deterioration of the displaying quality which is attributed to the sheet member contacting the display panel. With the configuration, it is possible to prevent the sheet member from being wrinkled while avoiding deterioration of the displaying quality.

Further, in addition to the above configuration, the illumination device may further include a sheet support arranged to support the sheet member, wherein the sheet support restricts a movement of the sheet member in a direction towards the display panel while allowing expansion and contraction of the sheet member in the direction the sheet member is curved.

In the configuration, the sheet member is able to expand or contract in a direction towards which the sheet member is curved. Thus, when the sheet member expands or contracts, it is possible to reduce a displacement amount (amount of bending) of the sheet member in a direction towards inside the illumination device. Further, by restricting the movement of the sheet member in the direction towards the display panel, it is possible to prevent the sheet member from contacting the display panel.

Further, in addition to the above configuration, the illumination device may further include sheet deformation restricting member arranged to restrict a deformation amount of the sheet member in a direction towards inside the illumination device.

With the configuration, it is possible to restrict a deformation amount of the sheet member in the direction towards inside the illumination device, with the use of the sheet deformation restricting member. Thus, it is possible to prevent the sheet member from contacting a member other than the sheet deformation restricting member. Further, it is possible to prevent the displaying quality from being negatively influenced by an increase in the deformation amount (amount of bending) of the sheet member in the direction towards inside the illumination device, or it is possible to reduce such a negative influence to the displaying quality.

Further, the illumination device may be adapted so that the illumination device is a direct illumination device including the light source in a region which overlaps a display region of the display panel when viewed from a position of a viewer viewing an image displayed on the display device; and the sheet deformation restricting member keeps a certain distance between the light source and the sheet member so that a figure of the light source is not seen by the viewer.

In the configuration, a space between the sheet member and the light source is kept at such a space that a figure of the light source (figure of the lamp) is not seen by the viewer, with the use of the sheet deformation restricting member. Thus, deterioration of the displaying quality which allows the viewer to see the figure of the light source is prevented.

Further, the illumination device may be adapted so that the sheet member is spherically curved so as to form the convex shape in a direction towards inside the illumination device.

Further, the illumination device may be adapted so that the sheet member has a quadrangle shape, and two sides of the quadrangle shape opposite to each other have a linear shape while two other sides are curved so as to form the convex shape in a direction towards inside the illumination device. In short, the sheet member may be curved to form an arch.

Further, the illumination device may further include a sheet support arranged to support the sheet member, wherein the sheet support restricts a movement of each of the two curved sides of the sheet member in a direction towards the display panel, while allowing the sheet member to expand or contract in a direction of a curvature of the sheet member.

In the configuration, the sheet member is able to expand or contract in a direction towards which the sheet member is curved. Thus, even when the sheet member expands or contracts, it is possible to reduce a displacement amount (amount of bending) of the sheet member in a direction towards inside the illumination device. Further, by restricting the movement of the sheet member in the direction towards the display panel, it is possible to prevent the sheet member from contacting the display panel.

With the configuration, it is possible to restrict a deformation amount of the sheet member in the direction towards inside the illumination device, with the use of the sheet support. Thus, it is possible to prevent the sheet member from contacting a member other than the sheet support provided inside the illumination device. Further, it is possible to prevent the displaying quality from being negatively influenced by an increase in the deformation amount (amount of bending) of the sheet member in the direction towards inside the illumination device, or it is possible to reduce such a negative influence to the displaying quality.

Further, the illumination device may be adapted so that the illumination device is a direct illumination device including the light source in a region which overlaps a display region of the display panel when viewed from a position of a viewer viewing an image displayed on the display device; and the sheet support keeps a certain distance between the light source and the sheet member so that a figure of the light source is not seen by the viewer.

In the configuration, a space between the sheet member and the light source is kept at such a space that a figure of the light source (figure of the lamp) is not seen by the viewer, with the use of the sheet support. Thus, deterioration of the displaying quality which allows the viewer to see the figure of the light source is prevented.

In order to achieve the foregoing advantages, a display device according to various preferred embodiments of the present invention is a transmissive display device which displays an image by using light from a light source having been transmitted through a display panel, including: a sheet member for passing light from the light source, wherein the sheet member is curved so as to form a convex shape in a direction opposite to the display panel.

With the configuration, the direction in which the sheet member is displaced due to bending of the optical sheet is limited to the direction towards the inside, even if the sheet member expands or contracts. Thus, cyclic deformation (wavelike wrinkle) on the sheet member is prevented.

Further, in the configuration, the displacement direction of the sheet member is limited to the direction towards the inside the illumination device. Therefore, the sheet member does not contact the display panel. Thus, it is possible to prevent deterioration of the displaying quality which is attributed to the sheet member contacting the display panel. That is, with the configuration, it is possible to prevent the sheet member from being wrinkled while avoiding deterioration of the displaying quality.

Further, the display device may further include a sheet support arranged to support the sheet member, wherein the sheet support restricts a movement of the sheet member in a direction towards the display panel while allowing expansion and contraction of the sheet member in the direction the sheet member is curved.

In the configuration, the sheet member is able to expand or contract in a direction towards which the sheet member is curved. Thus, even when the sheet member expands or contracts, it is possible to reduce a displacement amount (amount of bending) of the sheet member in a direction opposite to the display panel. Further, by restricting the movement of the sheet member in the direction towards the display panel, it is possible to prevent the sheet member from contacting the display panel.

Further, in addition to the above configuration, the display device may further include a sheet deformation restricting member arranged to restrict a deformation amount of the sheet member in a direction opposite to the display device.

With the configuration, it is possible to restrict a deformation amount of the sheet member in the direction opposite to the display panel, with the use of the sheet deformation restricting member. Thus, it is possible to prevent the sheet member from contacting a member other than the sheet deformation restricting member provided in the display device. Further, it is possible to prevent the displaying quality from being negatively influenced by an increase in the deformation amount (amount of bending) of the sheet member in the direction opposite to the display panel, or it is possible to reduce such a negative influence to the displaying quality.

Further, the display device may be adapted so that the light source is provided in a region overlapping a display region of the display panel, when viewed from a position of a viewer viewing an image displayed on the display device; and the sheet deformation restricting member keeps a certain distance between the light source and the sheet member so that a figure of the light source is not seen by the viewer.

In the configuration, a space between the sheet member and the light source is kept at such a space that a figure of the light source (figure of the lamp) is not seen by the viewer, with the use of the sheet deformation restricting member. Thus, deterioration of the displaying quality which allows the viewer to see the figure of the light source is prevented.

Further, the display device may be adapted so that the sheet member is spherically curved so as to form the convex shape in the direction opposite to the display panel.

Further, the display device may be adapted so that the sheet member has a quadrangle shape, and two sides of the quadrangle shape opposite to each other have a linear shape while two other sides are curved so as to form the convex shape in the direction opposite to the display device.

Further, the display device may further include a sheet support arranged to support the sheet member, wherein the sheet support restricts a movement of each of the two curved sides of the sheet member in a direction towards the display panel, while allowing the sheet member to expand or contract in a direction of a curvature of the sheet member.

In the configuration, the sheet member is able to expand or contract in a direction towards which the sheet member is curved. Thus, even when the sheet member expands or contracts, it is possible to reduce a displacement amount (amount of bending) of the sheet member in a direction towards inside the illumination device. Further, by restricting the movement of the sheet member in the direction towards the display panel, it is possible to prevent the sheet member from contacting the display panel.

With the configuration, it is possible to restrict a deformation amount of the sheet member in the direction opposite to the display device, with the use of the sheet support. Thus, it is possible to prevent the sheet member from contacting a member other than the sheet support. Further, it is possible to prevent the displaying quality from being negatively influenced by an increase in the deformation amount (amount of bending) of the sheet member in the direction opposite to the display panel, or it is possible to reduce such a negative influence to the displaying quality.

Further, the display device may be adapted so that the light source is provided in a region overlapping a display region of the display panel, when viewed from a position of a viewer viewing an image displayed on the display device; and the sheet support keeps a certain distance between the light source and the sheet member so that a figure of the light source is not seen by the viewer.

In the configuration, a space between the sheet member and the light source is kept at such a space that a figure of the light source (figure of the lamp) is not seen by the viewer, with the use of the sheet supporting member. Thus, deterioration of the displaying quality which allows the viewer to see the figure of the light source is prevented.

A television receiver according to another preferred embodiment of the present invention includes any one of the above-described display devices. Thus, it is possible to prevent the sheet member from being wrinkled while avoiding deterioration of the displaying quality.

The present invention is not limited to the preferred embodiments above, but may be altered within the scope of the claims. An embodiment based on a proper combination of technical means disclosed in different preferred embodiments is encompassed in the technical scope of the present invention.

The present invention is applicable to any transmissive display device which performs displaying by using light emitted from a backlight unit. For example, the present invention is applicable to television receivers, monitors of personal computers, or display devices to be mounted in or connected to various electronic devices.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-19. (canceled)

20: An illumination device for use in a transmissive display device which displays an image by using light from the illumination device having been transmitted through a display panel, comprising:
a light source; and
a sheet member arranged to pass light from the light source to outside the illumination device; wherein
the sheet member is curved so as to form a convex shape in a direction towards an interior of the illumination device.

21: The illumination device as set forth in claim 20, further comprising:
a sheet support arranged to support the sheet member, wherein
the sheet support restricts a movement of the sheet member in a direction towards the display panel while allowing expansion and contraction of the sheet member in the direction the sheet member is curved.

22: The illumination device as set forth in claim 20, further comprising:
a sheet deformation restricting member arranged to restrict a deformation amount of the sheet member in the direction towards inside the illumination device.

23: The illumination device as set forth in claim 22, wherein:
the illumination device is a direct illumination device including the light source in a region which overlaps a display region of the display panel when viewed from a position of a viewer viewing an image displayed on the display device; and
the sheet deformation restricting member is arranged to keep a certain distance between the light source and the sheet member so that a figure of the light source is not seen by the viewer.

24: The illumination device as set forth in claim 20, wherein:
the sheet member is spherically curved so as to form the convex shape in the direction toward the interior of the illumination device.

25: The illumination device as set forth in claim 20, wherein:
the sheet member has a quadrangle shape, and two sides of the quadrangle shape opposite to each other have a linear shape while two other sides are curved so as to form the convex shape in the direction towards the interior of the illumination device.

26: The illumination device as set forth in claim 25, further comprising:
a sheet support arranged to support the sheet member, wherein
the sheet support restricts a movement of each of the two curved sides of the sheet member in a direction towards the display panel while allowing expansion and contraction of the sheet member in the direction the sheet member is curved.

27: The illumination device as set forth in claim 26, wherein:
the illumination device is a direct illumination device including the light source in a region which overlaps a display region of the display panel when viewed from a position of a viewer viewing an image displayed on the display device; and
the sheet support keeps a certain distance between the light source and the sheet member so that a figure of the light source is not seen by the viewer.

28: The illumination device as set forth in claim 20, wherein:
the sheet member is curved so that, where a warpage amount of a side of 1 m in width is D, the warpage amount D is within a range from 2 mm to 8 mm.

29: A transmissive display device which displays an image by using light from a light source having been transmitted through a display panel, comprising:
a sheet member arranged to pass light from the light source; wherein
the sheet member is curved so as to form a convex shape in a direction opposite to the display panel.

30: The display device as set forth in claim 29, further comprising:
a sheet support arranged to support the sheet member, wherein
the sheet support restricts a movement of the sheet member in a direction towards the display panel while allowing expansion and contraction of the sheet member in the direction the sheet member is curved.

31: The display device as set forth in claim 29, further comprising:
a sheet deformation restricting member arranged to restrict a deformation amount of the sheet member in a direction opposite to the display device.

32: The display device as set forth in claim 31, wherein:
the light source is provided in a region overlapping a display region of the display panel, when viewed from a position of a viewer viewing an image displayed on the display device; and
the sheet deformation restricting member keeps a certain distance between the light source and the sheet member so that a figure of the light source is not seen by the viewer.

33: The display device as set forth in claim 29, wherein:
the sheet member is spherically curved so as to form the convex shape in the direction opposite to the display panel.

34: The display device as set forth in claim 29, wherein:
the sheet member has a quadrangle shape, and two sides of the quadrangle shape opposite to each other have a linear shape while two other sides are curved so as to form the convex shape in the direction opposite to the display device.

35: The display device as set forth in claim 34, further comprising:
a sheet support arranged to support the sheet member, wherein
the sheet support restricts a movement of each of the two curved sides of the sheet member in a direction towards the display panel while allowing expansion and contraction of the sheet member in the direction the sheet member is curved.

36: The display device as set forth in claim 35, wherein:
the light source is provided in a region overlapping a display region of the display panel, when viewed from a position of a viewer viewing an image displayed on the display device; and
the sheet support keeps a certain distance between the light source and the sheet member so that a figure of the light source is not seen by the viewer.

37: The illumination device as set forth in claim 29, wherein:
the sheet member is curved so that, where a warpage amount of a side of 1 m in width is D, the warpage amount D is within a range from 2 mm to 8 mm.

38: A television receiver comprising the display device as set forth in claim 29.
